(19) United States
(12) Patent Application Publication
(10) Pub. No.: US 2017/0203731 A1
(43) Pub. Date: Jul. 20, 2017

(54) SPOILER FOR FIN RAY WIPER

(71) Applicant: Robert Bosch GmbH, Stuttgart (DE)

(72) Inventors: Michael Weiler, Buehl (DE); Peter Deak, Budapest (HU); Peter Epacher, Balatonkenese (HU); Viktor Hackl, Sopron (HU)

(21) Appl. No.: 15/313,932

(22) PCT Filed: Apr. 29, 2015
(86) PCT No.: PCT/EP2015/059380

§ 371 Date: Nov. 23, 2016

(30) Foreign Application Priority Data
May 27, 2014 (DE) 10 2014 210 057.7

(51) Int. Cl. B60S 1/38

(52) U.S. Cl. CPC B60S 1/3806; B60S 1/3801; B60S 2001/3813

(57) ABSTRACT

The invention relates to a windshield wiper device (100) for a vehicle, comprising a wiper blade (2) having an elongated upper part (10) and an elongated lower part (12), which are configured to be flexible, at least in part. Furthermore, the device comprises a plurality of connecting elements (18) for connecting the upper part (10) and the lower part (12), said connecting elements being spaced apart from each other along a longitudinal extension (8) of the wiper blade (2) and being configured to allow a movement of the upper part (10 and the lower part relative to one another with a motion component along a longitudinal extension (8) of the wiper blade (2). A spoiler (19) is attached to at least one connecting element (18) in such a way that when there is an incident flow at the spoiler (19) the wiper blade (2) is pressed against a pane (4) of the vehicle.

### BACKGROUND OF THE INVENTION

The invention relates to a windshield wiper device for a vehicle, in particular a motor vehicle.

Windshield wiper devices typically have a wiper arm or wiper lever, wherein a wiper blade is moved over the windshield of a motor vehicle. The wiper blade is moved here between a first turning position and a second turning position. For this purpose, the wiper arm is connected via the drive shaft to a wiper motor. In particular on windshields having pronounced changes in curvature and at high incident flow speeds, the wiper blade easily loses contact with the windshield. In particular when there are unfavorable incident flow directions, this may result in wiping areas not being wiped or even in the wiper blade lifting off the windshield.

Since a wiping operation has to be optimized for a multiplicity of parameters, such as, for example, the amount of rain falling on the windshield, a possible snow loading on the windshield, the speed of the vehicle and associated wind pressure on the wiper arm, smearing cannot be reliably prevented in a simple manner by adaptation of the pressure of the wiper arm on the windshield. In addition, the windshield wiper device is sometimes exposed to great wind speeds which, in turn, may have a disadvantageous effect on the contact behavior of the wiper blade against the windshield. There is therefore a need for further improvement of windshield wiper devices.

A plurality of boundary conditions should additionally be taken into consideration for improvement purposes. There is also a need here to ensure a reliable contact pressure even at high driving speeds.

### SUMMARY OF THE INVENTION

It is the object of the present invention to ensure a reliable and substantially smear-free wiping of a windshield of a vehicle even when high incident flow speeds occur, wherein a sufficient contact pressure of the wiper blade against the windshield is ensured.

According to an embodiment of the present invention, a windshield wiper device for a vehicle, in particular a motor vehicle, is proposed. The windshield wiper device comprises a wiper blade with an elongate upper part and an elongate lower part, which are configured to be at least partially bendable. Furthermore, a plurality of connecting elements for connecting the upper part and the lower part are provided, wherein the connecting elements are spaced apart from one another along a longitudinal extent of the wiper blade and are attached movably to the upper part and/or to the lower part. The connecting elements are designed in order to permit a movement of the upper part and of the lower part relative to each other with a movement component along a longitudinal extent of the wiper blade. A spoiler is attached to at least one connecting element in such a manner that, when there is an incident flow at the spoiler, the wiper blade is pressed against a windshield of the vehicle. Therefore, even in the event of unfavorable wind conditions which may occur at high driving speeds, the wiping operation can be maintained reliably and with a sufficient contact pressure of the wiper blade against the windshield.

Preferred embodiments and particular aspects of the invention emerge from the dependent claims, the drawings and the present description.

According to the embodiments of the invention that are described here, windshield wiper devices for vehicles can be produced in a particularly favorable manner and for a plurality of different fields of use. Furthermore, the embodiments of the invention make it possible to ensure a reliable and substantially smear-free wiping of a windshield of a vehicle even when unfavorable incident flow conditions occur with respect to the wiper blade, wherein a contact pressure of the wiper blade against the windshield is provided to a sufficient extent.

According to an embodiment of the present invention, a windshield wiper device for a vehicle, in particular a motor vehicle, is proposed. The windshield wiper device comprises a wiper blade with an elongate upper part and an elongate lower part, which are configured to be at least partially bendable. Furthermore, a plurality of connecting elements for connecting the upper part and the lower part are provided, wherein the connecting elements are spaced apart from one another along a longitudinal extent of the wiper blade and are attached movably to the upper part and/or to the lower part. The connecting elements are designed in order to permit a movement of the upper part and of the lower part relative to each other with a movement component along a longitudinal extent of the wiper blade. A spoiler is attached to at least one connecting element in such a manner that, when there is an incident flow at the spoiler, the wiper blade is pressed against a windshield of the vehicle. Therefore, even in the event of unfavorable wind conditions which may occur at high driving speeds, the wiping operation can be maintained reliably and with a sufficient contact pressure of the wiper blade against the windshield.

According to yet further embodiments, the spoiler can be designed as a flat plate. The plate plane of the spoiler together with a longitudinal axis of the connecting element can enclose an angle which lies within a range of 50° to 130°, in particular between a range of 70° to 110°, and furthermore in particular at approximately 90°. This ensures that the wiper blade is securely placed against the windshield even in the event of changing incident flow directions and at high wind speeds.

According to yet further embodiments, the spoiler can have two plates which, together with the connecting element, form a triangular structure in the longitudinal section through the wiper blade. This improves a stability of the spoiler attached to the connecting element.

According to yet further embodiments, the spoiler can enclose two plates which, together with the connecting element, form an X shape in the longitudinal section through the wiper blade. The plate plane of one or both plates of the spoiler together with a longitudinal axis of the connecting element can enclose an angle which lies within a range of 50° to 130°, in particular within a range of 70° to 110°, and furthermore in particular at approximately 90°. This ensures that the wiper blade is securely placed against the windshield even in the event of changing incident flow directions and at high wind speeds.

According to yet further embodiments, the spoiler can have two plates which, together with the connecting element, form a V shape in the longitudinal section through the wiper blade. By means of such an arrangement, the advantage can be obtained that a connection between the upper part and the lower part of the wiper blade can be provided with a predetermined elasticity. In particular, it is expedient if the spoiler is formed together with the connecting element so as to be elastic in a direction of the action of force in such a manner that an overload protection is provided.

According to yet further embodiments, the spoiler can have two plates which, together with the connecting element, form a T shape in the longitudinal section through the wiper blade. Such a T shape makes it possible for a sufficient contact pressure of the wiper blade against the windshield of the motor vehicle to be maintained even in the event of complex incident flow conditions.

According to yet further embodiments, the upper part, the lower part, the connecting elements and the at least one spoiler are formed as an integral component by injection molding. This affords advantages in terms of manufacturing, permitting a cost-effective production of the wiper blade together with the at least one spoiler.

According to embodiments, the at least one spoiler can contain a material from the group which consists of POM, PA, TPE, in particular TPE-S, TPE-O, TPE-U, TPE-A, TPE-V and TPE-E, or any combination thereof. The advantage is therefore obtained that, by means of a suitable selection of material, physical and in particular mechanical properties of the spoiler can be set. Furthermore, it is advantageous if the spoiler together with the associated connecting element and/or the upper part and/or the lower part is formed integrally from the same or a similar material.

### BRIEF DESCRIPTION OF THE DRAWINGS

Exemplary embodiments of the invention are illustrated in the figures and are described in more detail below. In the figures:

FIG. 1 shows a schematic illustration of a wiper blade in a longitudinal sectional view, in the presence of an incident flow in an incident flow direction which causes the wiper blade to be pressed against the windshield,

FIG. 2 shows a schematic illustration of a wiper blade in a longitudinal sectional view, in the presence of an incident flow in an incident flow direction which causes the wiper blade to be at least partially lifted off the windshield,

FIG. 3 shows a schematic illustration of the wiper blade shown in FIG. 1, wherein the wiper blade has at least one spoiler, according to embodiments of the present invention,

FIG. 4A shows a schematic illustration of a further wiper blade, wherein at least one spoiler which has a plate-like structure is arranged on the wiper blade, according to embodiments of the present invention,

FIG. 4B shows a schematic illustration of yet another wiper blade, wherein at least one spoiler which has a triangular structure is arranged on the wiper blade, according to embodiments of the present invention,

FIG. 4C shows a schematic illustration of yet another wiper blade, wherein at least one spoiler which has a V-shaped structure is arranged on the wiper blade, according to embodiments of the present invention,

FIG. 4D shows a schematic illustration of yet another wiper blade, wherein at least one spoiler which has a T-shaped structure is arranged on the wiper blade, according to embodiments of the present invention,

FIG. 4E shows a schematic illustration of yet another wiper blade, wherein at least one spoiler which has a X-shaped structure is arranged on the wiper blade, according to embodiments of the present invention,

FIG. 5A shows a schematic illustration of a further exemplary embodiment of a windshield wiper device according to the invention in the form of a wiper arm with an integrated wiper blade in a basic position,

FIG. 5B shows a schematic illustration of the wiper arm with an integrated wiper blade according to FIG. 5A in a position placed against a windshield,

FIG. 6 shows a schematic illustration of a wiper blade according to embodiments of the present invention in a basic position, and

FIG. 7 shows a schematic illustration of a wiper blade according to embodiments of the present invention in a position placed against a windshield.

### DETAILED DESCRIPTION

Unless noted differently, the same reference signs are used below for identical and identically acting elements.

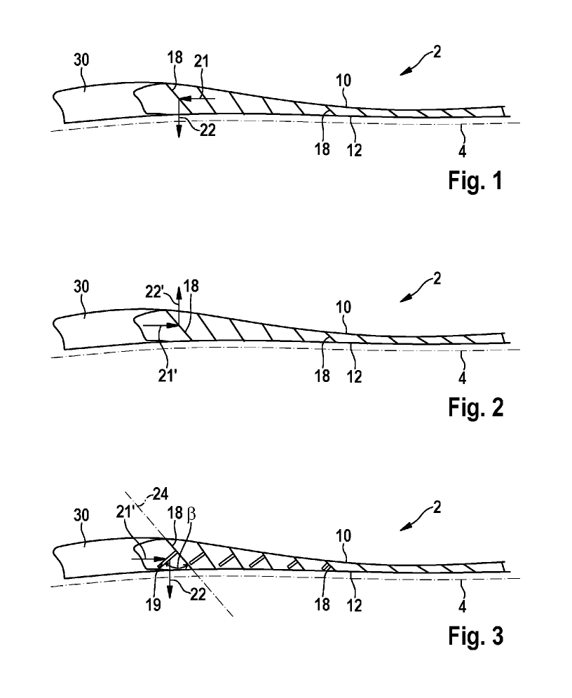

FIGS. 1 and 2 illustrate the influence of an incident flow from different sides with respect to a wiper blade 2. FIG. 1 shows a schematic illustration of a wiper blade 2 of a windshield wiper device for a vehicle, in particular for a motor vehicle, in a longitudinal sectional view. The wiper blade 2 comprises an elongate upper part 10 and an elongate lower part 12, which are considered to be at least partially bendable. Furthermore, a plurality of connecting elements 18 for connecting the upper part 10 and the lower part 12 are provided, wherein the connecting elements 18 are spaced apart from one another along a longitudinal extent 8 of the wiper blade 2. The connecting elements 18 are designed in order to permit a movement of the upper part 10 and of the lower part 12 relative to each other with a movement component along a longitudinal extent 8 of the wiper blade 2. The upper part 10 and the lower part 12 are attached to a fastening part 30 which is suitable to be connected, for example, to a quick fix fastening to the vehicle.

A reference sign 21 indicates the presence of an incident flow with an incident flow direction on at least one connecting element 18, as a result of which the wiper blade 2 is pressed against the windshield 4 in the direction of action of force 22. In the situation shown in FIG. 1, the flow is incident at the connecting element 18 from the right (i.e. in the direction of the arrow 21) and therefore a direction of action of force 22 points toward the windshield 4 and the wiper blade 2 is pressed against the windshield 4.

FIG. 2 shows a schematic illustration of the wiper blade 2, which is described above with reference to FIG. 1, in a longitudinal sectional view, in the event of the presence of an incident flow in an incident flow direction 21′ which can cause the wiper blade 2 to at least partially lift off from the windshield 4. In the situation shown in FIG. 2, the flow is incident at the connecting element 18 from the left (i.e. in the direction of the arrow 21′), and therefore the direction of action of force 22′ points away from the windshield 4 and the wiper blade 2 can lift off from the windshield 4. The incident flow at the wiper blade from the left, as corresponds to the situation shown in FIG. 2, therefore leads to a deterioration in the wiping effect since the contact pressure 4 is reduced. In particular, an incident flow in the incident flow direction 21′ shown in FIG. 2 can act as a lifting-off aid for the wiper blade 2 from the windshield 4 in such a manner that considerable wiping errors may be caused.

FIG. 3 is a schematic illustration of the wiper blade 2 shown in FIG. 1, wherein the wiper blade 2 has at least one spoiler 19, according to embodiments of the present invention. At least one plate-like spoiler 19 is attached to at least one connecting element 18. In this case, the plate of the spoiler 19 together with a longitudinal axis 24 of the connecting element encloses an angle β which lies within a range of 50° to 130°, in particular within a range of 70° to 110°, and furthermore in particular at approximately 90°.

It should be emphasized here that the quality of the wiping operation, in particular in the case of the fin ray wiper, depends greatly on the contact pressure of the wiper blade 2 against the windshield 4 of the vehicle, wherein the contact pressure in turn determines the required driving torque of the windshield wiper device. In one approximation, the driving torque is proportional to the contact pressure of wiper blade 2 against the windshield 4.

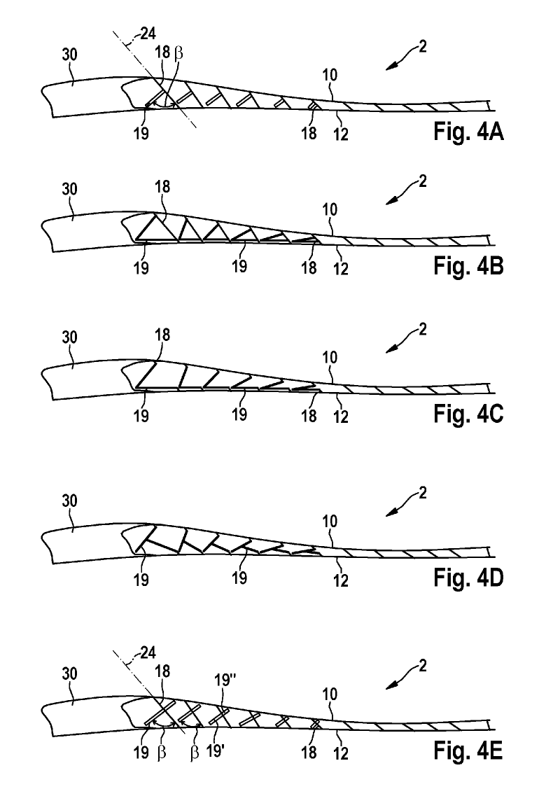

Various variants of spoilers 19 which are particularly advantageous for the windshield wiper devices of the embodiments described here are explained below. FIGS. 4A to 4E each show wiper blades 2 having different spoilers 19 which each correspond to different embodiments. The spoilers 19 are in each case attached here to at least one connecting element 18 or are integrated therewith.

FIG. 4A is a schematic illustration of the wiper blade 2 shown in FIG. 3, wherein at least one spoiler 19 which has a plate-like structure is arranged on at least one connecting element 18 of the wiper blade 2, according to embodiments of the present invention. The plate plane of the spoiler 19 together with a longitudinal axis 24 of the connecting element can enclose an angle β which lies within a range of 50° to 130°, in particular within a range of 70° to 110°, and furthermore in particular at approximately 90°. This ensures that the wiper blade 2 is securely placed against the windshield 4 even in the event of changing incident flow directions, i.e. from the left and from the right in FIG. 4A, and at high wind speeds. By means of the arrangement shown in FIG. 4A, the wiper blade 2 is therefore pressed against the windshield 4 in the event of an incident flow from any incident flow direction 21, 21′, i.e. from the right and/or from the left in the figures.

FIG. 4B shows a schematic illustration of a wiper blade 2 in a longitudinal sectional view, according to a further embodiment, which can be combined with embodiments described herein. At least one spoiler 19 which has a triangular structure is arranged on at least one connecting element 18 of the wiper blade 2. In a similar manner as in the case of the spoiler 19 shown in FIG. 4A, the triangular structure of the spoiler 19 brings about a secure placing of the wiper blade 2 against the windshield 4 even in the event of an incident flow from changing incident flow directions 21, 21′, i.e. from the left and from the right in FIG. 4B, and also at high wind speeds. By means of the design of the spoiler 19 that is illustrated in FIG. 4B, a stability of the spoiler 19 attached to the connecting element 18, or of the integral unit consisting of connecting element 18 and spoiler 19, can be further improved in an expedient manner.

FIG. 4C shows a schematic illustration of a wiper blade 2 in a longitudinal sectional view, according to a further embodiment, which can be combined with embodiments described herein. The spoiler 19 here has two plates which, together with the connecting element 18 or at least with parts of the connecting element 18, form a V shape in the longitudinal section through the wiper blade 2. According to an embodiment which can be combined with other embodiments described herein, the spoiler 19 and at least parts of the connecting element 18 form an integral unit which itself acts as a connecting element between the upper part 10 and the lower part 12. By means of such an arrangement of a connecting element 18 together with the spoiler 19, a certain elasticity can be provided in the connection between the upper part 10 and the lower part 12 of the wiper blade 2. By this means, it is possible for the spoiler 19 together with the connecting element 18 to react elastically to an acting force, as a result of which an overload protection can be provided.

FIG. 4D is a schematic illustration of a wiper blade 2, wherein at least one spoiler 19 which has a T-shaped structure is arranged on the wiper blade 2, according to embodiments of the present invention which can be combined with other embodiments described herein. The shown spoiler 19 here has two plates which, together with the connecting element 18, form the T shape in the longitudinal section through the wiper blade 2. According to a further embodiment which can be combined with embodiments described herein, the entire T-shaped spoiler 19 acts at the same time as a connecting element. By means of such a construction with a T shape in the longitudinal section through the wiper blade 2, it is possible to maintain a sufficient contact pressure of the wiper blade 2 against the windshield 4 of the motor vehicle even in the event of complex incident flow conditions.

FIG. 4E is a schematic illustration of a wiper blade 2 with a spoiler arrangement according to yet another embodiment of the present invention, which may be combined with other embodiments described herein. At least one spoiler 19 which, at least partially in combination with at least one connecting element 18, has an X-shaped structure is attached to the wiper blade 2 illustrated in FIG. 4E. The spoiler 19 here can have two plates 19′, 19″ which, together with the connecting element 18, form the X shape in the longitudinal section through the wiper blade 2. The plate plane of one or both plates of the spoiler 19 can enclose, together with a connecting-element longitudinal axis 24 of the associated connecting element 18, an angle β which lies within a range of 50° to 130°, in particular within a range of 70° to 110°, and furthermore in particular at approximately 90°. This ensures that the wiper blade 2 is placed securely against the windshield 4 even in the event of changing incident flow directions and at high wind speeds.

It should be pointed out here that all of the spoiler variants described with respect to FIGS. 4A, 4B, 4C, 4D and 4E can furthermore be designed as overload stopping devices. In this connection, in particular the spoiler variants of V shape (FIG. 4C) and of T shape (FIG. 4D) have the additional advantage of being flexible in a pressure direction, as a result of which said variants are expediently used as an overload protection in the event of excessively high pressure or tension and in the event of a large torsional force which may act on the connecting elements (ribs) 18 of the wiper blade 2.

According to embodiments of the wiper blade 2, which may be combined with other embodiments, the above-stated spoiler variants are formed by injection molding. This makes it possible to afford advantages in terms of manufacturing which permit a cost-effective production of the wiper blade together with the corresponding spoiler variant. In particular, it is expedient to design the upper part 10, the lower part 12, the connecting elements 18 or at least parts of the connecting elements 18 and the desired spoiler variant as an integral component by injection molding.

According to embodiments of the wiper blade 2, which may be combined with other embodiments, the above-stated spoiler variants contain at least one material from the group which consists of POM, PA, TPE, in particular TPE-S, TPE-O, TPE-U, TPE-A, TPE-V and TPE-E, or any combination thereof. By means of a suitable selection of material, it is possible to predetermine physical and in particular mechanical properties of the spoiler 19, in particular if the spoiler 19 is formed integrally together with the associated connecting element 18 and/or the upper part 10 and/or the lower part 12 from the same or similar material.

Aspects of an illustrative windshield wiper device for which the embodiments of the windshield wiper device that are described herein, in particular the spoilers 19, 19′, 19″ which are described herein, are particularly advantageous are described below.

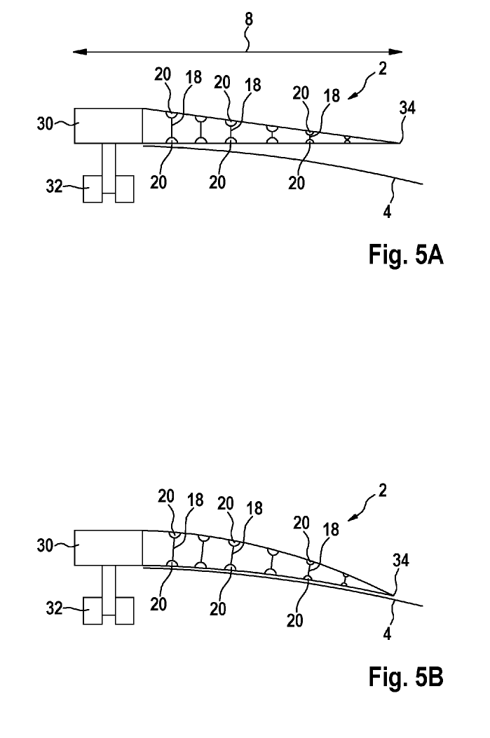

FIGS. 5A and 5B show schematic illustrations of a wiper blade 2 in a basic position and in a position placed against a windshield according to embodiments of the windshield wiper device of the disclosure. Fin ray wipers for which spoilers 19 according to the embodiments described here are particularly useful are described here. The at least one spoiler 19 is not illustrated again in FIGS. 5A, 5B, 6 and 7 and can also be provided in these embodiments, as previously described. The wiper blade 2 serves for wiping the windshield 4 of a vehicle which is, for example, a motor vehicle, in particular a car. The wiper blade 2 has a longitudinal extent 8 and an elongate upper part 10 and a likewise elongate lower part 12. The longitudinal extents of the upper part 10 and of the lower part 12 substantially correspond to the longitudinal extent 8 of the wiper blade 2.

Both the upper part 10 and the lower part 12 are bendable beams or may be configured as bendable beams. It is likewise possible for in each case only one part of the upper part 10 and/or of the lower part 12 to be configured to be bendable. According to some embodiments that may be combined with other embodiments described here, a material that has a modulus of elasticity in a range between 0.005 kN/mm² and 0.5 kN/mm², in particular 0.01 kN/mm² and 0.1 kN/mm², is used for the upper part 10 and/or the lower part 12. This makes it possible to realize suitable bendability of the upper part 10 and of the lower part 12. Together with a suitably configured cross-sectional area of the upper part 10 and of the lower part 12, optimum flexural rigidity is thus attained.

The upper part 10 and the lower part 12 are fastened to the fastening part 30. The windshield wiper device can be connected to the vehicle by means of the fastening part 30, for example with a quick fix fastening. On the side which lies opposite the fastening part 30 along the longitudinal extent of the windshield wiper device, the upper part 10 and the lower part 12 are connected at a connecting position 34. The connecting elements are configured in such a manner that the distance of the connecting position with the upper part and the distance of the connecting position of the lower part changes by at maximum +−1 mm, in particular by a maximum +−0.3 mm (for example by thermal expansion and/or tension and compressive loading). The connecting elements can therefore be of substantially inelastic design or the effect of the connecting elements is based on the force transmission thereof between upper part and lower part and not on the elasticity thereof.

The upper part 10 and the lower part 12 are connected to each other by connecting elements 18. The connecting elements 18 are fastened to mutually facing inner longitudinal sides of the upper part 10 and of the lower part 12 by means of rotary joints 20. The rotary joints 20 are typically hinges. In particular, the rotary joints 20 may be in the form of film hinges. This is advantageous in particular if the upper part 10, the lower part 12 and/or the connecting elements 18 are produced from a plastics material or are coated with a suitable plastics material.

According to typical embodiments described here, which may be combined with other embodiments described here, a rotary joint is selected from the following group consisting of: a hinge, a film hinge, a narrowing of the material for the purpose of generating reduced rigidity along a torsional axis, a joint with an axis of rotation, a means for connecting the upper part to the connecting element or for connecting the lower part to the connecting element, which means permits the displacement of the lower part in relation to the upper part along the longitudinal extent, etc.

Embodiments in which the joints are provided by film hinges thus constitute a very simple way of providing the joints for a fin ray wiper. The wiper blade 2 may be provided in one piece, in particular in ready-from-the-mold form. According to typical embodiments, the film hinges exhibit high ductility. This can be provided, for example, by means of a material selected from the group PP, PE, POM and PA. Alternatively, the film hinges may be produced from one or more materials from a group consisting of: TPE (Thermoplastic Elastomer), for example TPE-S, TPE-O, TPE-U, TPE-A, TPE-V and TPE-E.

The connecting elements 18 are spaced apart from one another along the longitudinal extent of the wiper blade 2. The spacings are advantageously less than 50 mm, in particular less than 30 mm. In this way, it is possible to ensure particularly great flexibility of the windshield wiper device, in particular of its lower part, and good adaptation to the curvature and changes in curvature of the windshield to be wiped.

FIG. 5B shows a schematic illustration of the wiper blade 2 according to FIG. 5A in a position placed against the windshield 4. Since the windshield 4 has a curvature, contact pressure forces act on the lower part 12 when the wiper blade 2 is placed against the windshield 4. Since the upper part 10 and the lower part 12 are bendable beams and the connecting elements 18 are mounted rotatably on upper part 10 and lower part 12, the upper part 10 and the lower part 12 are displaceable in relation to each other. By means of the compressive forces acting on the lower part 12 from below, the wiper blade 2 bends in the same direction from which the compressive forces come and is placed precisely against the curvature of the windshield 4.

By means of the construction of the embodiments described here, in the event of an action of force on the lower part (by means of the windshield 4), the lower part bends in the direction from which the force acts. This is provided by the connection of the upper part 10 and of the lower part to the connecting position 34, by the shape and by rotary joints at the connection between the connecting elements and the upper or lower part. A windshield wiper device according to the embodiments described here uses the effect of tail fins of certain fish, which tail fins do not yield in the direction of pressure in the event of lateral pressure, but rather arch in the opposite direction, i.e. in the direction from which the pressure comes. This principle is also referred to as the fin ray principle. As a result, a windshield wiper device according to the embodiments described herein has the advantage of improved adaptation to a windshield of a motor vehicle. In the case of a conventional windshield wiper blade, the upper part thereof is customarily rigid, i.e. it is not of bendable design.

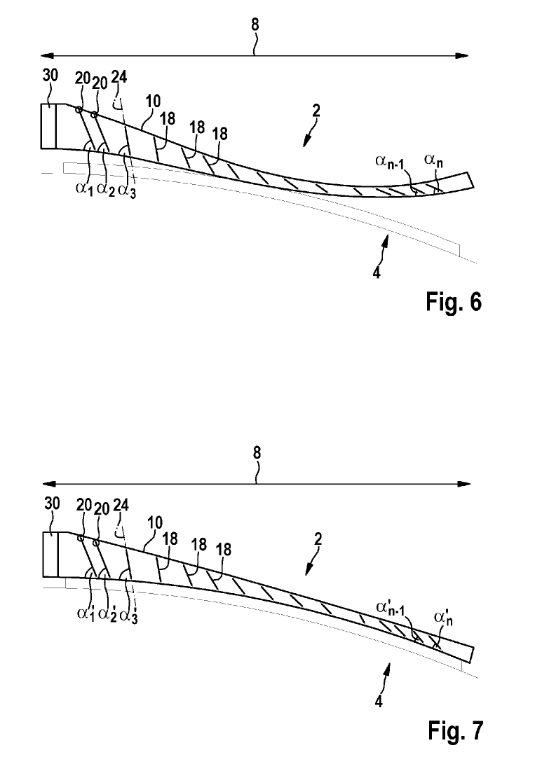

FIGS. 6 and 7 show schematic illustrations of a wiper blade 2 of a windshield wiper device for a vehicle, in particular for a motor vehicle, in a basic position (FIG. 6), i.e. in an unloaded state, and in a position placed against a windshield 4 (FIG. 7), according to the embodiments described herein. The wiper blade 2 comprises an elongate upper part 10 and an elongate lower part 12, which are configured to be at least partially bendable. Furthermore, a plurality of connecting elements 18 for connecting the upper part 10 and the lower part 12 are provided, wherein the connecting elements 18 are spaced apart from one another along a longitudinal extent 8 of the wiper blade 2. The connecting elements 18 are designed in order to permit a movement of the upper part 10 and of the lower part 12 relative to each other with a movement component along a longitudinal extent 8 of the wiper blade 2. Furthermore, the connecting elements 18 are arranged relative to the lower part 12 in such a manner that, in an unloaded state of the wiper blade 2, an angle αₙ of the respective longitudinal axes 24 of the connecting elements 18 relative to the lower part 12 at least partially changes along a longitudinal extent 8 of the wiper blade 2, in particular changes continuously or changes monotonously or strictly monotonously.

In the wiper blade illustrated in FIG. 6 in the unloaded state, the angles αₙ of the respective longitudinal axes of the connecting elements 18 relative to the lower part 12, which angles change along the longitudinal extent 8 of the wiper blade 2, are referred to by α₁, α₂, α₃, . . . αₙ₋₁, αₙ. In a loaded state of the wiper blade, i.e. in a position placed against the windshield, as is illustrated by way of example in FIG. 7, the angles αₙ of the respective longitudinal axes 24 of the connecting elements 18 relative to the lower part 12 change in comparison to the unloaded state. In order to convey this, the angles αₙ of the respective longitudinal axes of the connecting elements 18 relative to the lower part 12, which angles change along the longitudinal extent 8 of the wiper blade 2, are denoted in the wiper blade which is illustrated in FIG. 2 and which is in a position placed against the windshield by α′₁, α′₂, α′₃, . . . αₙ₋₁, α′ₙ.

According to embodiments of the windshield wiper device, which can be combined with other embodiments, the wiper blade 2 has at least one first region in which the angle αₙ of the longitudinal axes 24 of the connecting elements 18 relative to the lower part 12 decreases along a longitudinal extent 8 of the wiper blade 2 toward a wiper blade end, in particular decreases monotonously, in particular strictly monotonously. Furthermore, the wiper blade 2 can have at least one second region in which the angle αₙ of the longitudinal axes 24 of the connecting elements 18 relative to the lower part 12 increases along a longitudinal extent 8 of the wiper blade 2 toward a wiper blade end, in particular increases monotonously, in particular strictly monotonously. According to embodiments as illustrated by way of example in FIGS. 6 and 7, the second region of the wiper blade, in which the angle αₙ of the longitudinal axes 24 of the connecting elements 18 relative to the lower part 12 increases along the longitudinal extent 8 of the wiper blade 2 toward a wiper blade end, is arranged at an inner position of the wiper blade that is located in the vicinity of a fastening device 30 of the wiper blade. This makes it possible to provide a windshield wiper device which permits particularly good adaptation to the curvature of a windshield. Furthermore, a substantially uniform contact pressure of the windshield wiper device against the windshield and also a homogeneous distribution of force over the windshield wiper device can be provided, and therefore a high wiping quality is provided.

According to embodiments of the wiper blade, which can be combined with other embodiments, the connecting elements 18, in particular in an unloaded state of the wiper blade 2, are fastened to the lower part 12 in such a manner that the longitudinal axes 24 of the connecting elements 18 run at angles αₙ with respect to the lower part 12, which angles lie between a lower angle limit value αₙᵤ and an upper limit value αₙₒ. According to embodiments, the lower angle limit value αₙₒ=10°, in particular αₙₒ=15°, in particular αₙᵤ=20°, and the upper angle limit value is αₙₒ=80°, in particular αₙₒ=90°, in particular αₙₒ=100°. This advantageously ensures a particularly good transmission of a force, which acts on the lower part, to the upper part.

According to embodiments of the windshield wiper device, which may be combined with other embodiments, the connecting elements 18 are configured in such a manner that the spacing between the upper part 10 and the lower part 12 at least partially changes along a longitudinal extent 8 of the wiper blade 2, in particular continuously decreases in a first region and continuously increases in a second region. The spacing between the upper part 10 and the lower part 12 along the longitudinal extent 8 of the wiper blade 2 may also include a region in which the spacing between the upper part 10 and the lower part 12 along the longitudinal extent 8 of the wiper blade 2 is substantially constant. The spacing between the upper part 10 and the lower part 12 is greater on the fastening part than at the opposite end.

According to embodiments of the wiper blade, which may be combined with other embodiments, the inner spacing value (facing the fastening part) is at least 15 mm, in particular at least 25 mm, in particular at least 35 mm. According to embodiments which may be combined with other embodiments, the outer spacing value is at least 10 mm, in particular at least 12.5 mm, in particular at least 15 mm. According to embodiments which may be combined with other embodiments, the average spacing value is at least 7.5 mm, in particular at least 9 mm, in particular at least 12.5 mm.

As illustrated by way of example in FIGS. 6 to 7, the connecting elements 18 according to embodiments which may be combined with other embodiments are connected in an articulated manner to the lower part 12 and/or to the upper part 10. In particular, the connecting elements 18 are connected to the lower part 12 and/or to the upper part 10 by means of a first film hinge 20. The first film hinge 20 can be formed integrally with the connecting element 18 and the upper part 10 and/or the lower part 12. The integral configuration of the film hinges permits a simple and cost-effective production.

According to embodiments of the wiper blade, which may be combined with other embodiments described herein, the wiper blade comprises a first region with a first curvature ω<0 and a second region with a second curvature ω>0. Furthermore, the wiper blade according to embodiments may have a third region with a third curvature ω<0, wherein the second region of the wiper blade is arranged with the second curvature ω>0 between the first region with the first curvature ω<0 and the third region with the third curvature ω<0, as is shown by way of example in FIG. 6. A windshield wiper device can therefore be provided with which a substantially uniform contact pressure against the windshield 4 can be realized. Furthermore, a windshield wiper device can be provided which has improved adaptation to the windshield 4 and a high wiping quality.

In addition to a quick fix fastening closure which is able to be used for fin ray wipers and in which the entire windshield wiper device is removed from a drive axis on the vehicle, a mechanism can be provided in order to lift the wiper blade 2 of a windshield wiper device from the windshield 4 and/or to place said wiper blade thereagainst. This further simplifies the use, for example for manual cleaning of the windshield 2.

1. A windshield wiper device for a vehicle, comprising a wiper blade (2) with
an elongate upper part (10), which is configured to be at least partially bendable,
an elongate lower part (12), which is configured to be at least partially bendable, and
a plurality of connecting elements (18) for connecting the upper part (10) and the lower part (12), wherein the connecting elements (18) are spaced apart from one another along a longitudinal extent (8) of the wiper blade (2) and are attached movably to the upper part (10) and/or to the lower part (12), wherein the connecting elements (18) are configured to permit a movement of the upper part (10) and the lower part relative to each other with a movement component along a longitudinal extent (8) of the wiper blade (2), wherein a spoiler (19) is attached to at least one of the connecting elements (18) in such a manner that, when there is an incident flow at the spoiler (19), the wiper blade (2) is pressed against a windshield (4) of the vehicle.

2. The windshield wiper device as claimed in claim 1, wherein the spoiler (19) is a flat plate.

3. The windshield wiper device as claimed in claim 1, wherein the spoiler (19) is attached to the one of the connecting elements (18) at an angle (β) to a longitudinal axis (24) of the connecting element (18), wherein the angle (β) lies within a range of 50° to 130°.

4. The windshield wiper device as claimed in claim 1, wherein the spoiler (19) comprises two plates which, together with the one of the connecting elements (18), form a triangular structure in a longitudinal section through the wiper blade (2).

5. The windshield wiper device as claimed in claim 1, wherein the spoiler (19) comprises two plates which, together with the one of the connecting elements (18), form an X shape in a longitudinal section through the wiper blade (2).

6. The windshield wiper device as claimed in claim 1, wherein the spoiler (19) comprises two plates which, together with the one of the connecting elements (18), form a V shape in a longitudinal section through the wiper blade (2).

7. The windshield wiper device as claimed in claim 1, wherein the spoiler (19) comprises two plates which, together with the one of the connecting elements (18), form a T shape in the longitudinal section through the wiper blade (2).

8. The windshield wiper device as claimed in claim 7, wherein the spoiler (19) is formed together with the one of the connecting elements (18) so as to be elastic in a direction of action of force (22) in such a manner that an overload protection is provided.

9. The windshield wiper device as claimed in claim 1, wherein the upper part (10), the lower part (12), the connecting elements (18) and the at least one spoiler (19) are formed as an integral component by injection molding.

10. The windshield wiper device as claimed in claim 1, wherein the spoiler (19) contains at least one material from the group which consists of POM, PA, TPE, in particular TPE-S, TPE-O, TPE-U, TPE-A, TPE-V and TPE-E, or any combination thereof.

11. The windshield wiper device as claimed in claim 1, wherein the spoiler (19) is attached to the one of the connecting elements (18) at an angle (β) to a longitudinal axis (24) of the connecting element (18), wherein the angle (β) lies within a range of 70° to 110°.

12. The windshield wiper device as claimed in claim 1, wherein the spoiler (19) is attached to the one of the connecting elements (18) at an angle (β) of approximately 90°.
